(19) United States
(12) Patent Application Publication
(10) Pub. No.: US 2017/0230756 A1
(43) Pub. Date: Aug. 10, 2017

(54) MEMS LOUDSPEAKER DEVICE AND CORRESPONDING MANUFACTURING METHOD

(71) Applicant: Robert Bosch GmbH, Stuttgart (DE)

(72) Inventors: Christoph Schelling, Stuttgart (DE); Thomas Northemann, Gerlingen (DE)

(21) Appl. No.: 15/426,610

(22) Filed: Feb. 7, 2017

(30) Foreign Application Priority Data
Feb. 8, 2016 (DE) 102016201872.8

(51) Int. Cl. H04R 19/02; H04R 1/28; H04R 31/00; H04R 7/12

(52) U.S. Cl. CPC H04R 19/02; H04R 7/125; H04R 1/2803; H04R 31/003; H04R 2201/003

(57) ABSTRACT

A MEMS loudspeaker device and a corresponding manufacturing method are described. The MEMS loudspeaker device includes a first substrate having a first front side and a first rear side, which includes a first rear side cavity, which is at least partially covered by a sound generation device; a second substrate having a second front side and a second rear side, which includes a second rear side cavity, which is covered by a first perforated plate device; the second rear side being bonded to the first front side in such a way that the second rear side cavity is situated above the sound generation device; and a second perforated plate device, which is attached above the first perforated plate device; at least one of the first perforated plate device and of the second plate device being elastically deflectable in such a way that a passage of sound of the sound generation device may be modulated by an interaction of the first perforated plate device and the second perforated plate device.

### FIELD OF THE INVENTION

The present invention relates to a MEMS loudspeaker device and a corresponding manufacturing method.

### BACKGROUND INFORMATION

Although arbitrary micromechanical substrates are also applicable, the present invention and the problem underlying it are explained with reference to silicon-based MEMS substrates.

The design of competitive MEMS loudspeakers has previously been complicated by the fact that no sufficiently high sound levels can be achieved at low frequencies. Due to the physical properties, a quadratic increase of the sound pressure P with the angular frequency results in the far sound field according to the following formula:

P=ρ·d²·h₀·ω²/8R

in which ρ is the density of the air, d is the diameter of the diaphragm, h₀ is the maximum deflection of the diaphragm, R is the distance of the “listener” and w is the angular frequency. Standardizing this sound pressure P to a reference pressure p₀=20 μPa and forming the logarithm, yields the sound pressure level (SPL):

SPL=20 log₁₀(P/P₀)

When the SPL, German “sound pressure level” or “sound level” for short, is now plotted over the frequency, an increase of 40 dB/decade becomes apparent due to the quadrative increase of the sound pressure over the frequency. This finding may also be differently worded: at low frequencies, the sound level drops at 40 dB/decade. As a result, low frequencies (bass) are difficult to establish. An ideal loudspeaker shows a constant sound level profile over the entire audible frequency range (20 Hz-20 kHz).

The principle of a micromechanical ultrasonic loudspeaker, which provides a constant sound level over the entire audible range and, therefore, enables high sound levels even at low frequencies, is described in WO 2015/11 96 28 A2. The loudspeaker described therein has an ultrasonic-generating diaphragm, which oscillates at a first frequency, an acoustically transparent backplate (also referred to as a back plate) and a shutter modulating the ultrasound (also referred to as a closing device), which oscillates at a second variable frequency. However, the configuration described therein on a single substrate results in a strong fluidic coupling of the movements of the sound-generating diaphragm and the modulating shutter via the rigid gas spring due to the small volume (between the diaphragm and the shutter).

### SUMMARY

The present invention provides a MEMS loudspeaker device and a corresponding manufacturing method.

The idea underlying the present invention is that rear side cavities are formed in a first and in at least one second substrate each, the first substrate and second substrate being connected to one another and at least one sound generation device, for example, an ultrasound-generating diaphragm or at least one cantilever being implemented in the first substrate. At least one rigid, perforated backplate and one elastically deflectable shutter are implemented in the second substrate. Alternatively, the backplate and the shutter are implemented in the third substrate or two shutters are implemented either on the second substrate or on the second and on a third substrate, respectively. Additional shutters and/or backplates are also possible.

For the MEMS loudspeaker according to the ultrasonic down-conversion principle, it is particularly advantageous to attenuate the free movement of the sound generation device, for example, the ultrasound-emitting diaphragm as little as possible and to decouple it from the movement of the shutter. The movement of the sound generation device, for example, the ultrasound-emitting diaphragm, is attenuated by the gas spring constants on both sides of the diaphragm. The gas spring constant is a function of the back volume (the greater the back volume, the smaller the spring constant and, therefore, the attenuation), which is why a preferably large back volume is advantageous. This may be located in the substrate cavity (approximately 100 μm-800 μm deep) of the first substrate, and may also be connected in a chamber in the packaging or via a rear-side opening. The same applies to the gas spring of the intermediate volume between the sound generation device, for example, the ultrasound-emitting diaphragm, and the backplate/shutter. The high fluid resistance when the shutter is closed results in a vertical excitation of the shutter, which would make it difficult to control an independent shutter movement in the vertical direction. A lateral drive of the shutter (linear or rotatory movement in the plane) is therefore preferable. Both a piezoelectric drive as well as an electrostatic drive are implementable.

An electrostatic drive of the sound generation device, for example, the diaphragm, would require an additional stationary electrode, situated vertically, which would lead to a fluid attenuation due to the associated squeeze film attenuation A piezoelectric drive is therefore preferable. In addition, a low-mass sound generation device, for example, the ultrasound-emitting diaphragm is desirable for the operation. This is caused, for example, by a high natural frequency of the diaphragm, for example, by low mass density or low diaphragm thickness (1-20 μm).

The shutter should be designed as a thick functional layer (preferably >5 μm), so that a high rigidity in the vertical direction results and the pressure shocks of the sound generation device, for example, the ultrasound-emitting diaphragm, may be absorbed without the shutter striking the backplate. In the event the shutter could still strike the back plate or the second shutter vertically, stop bumps could be provided, for example, on the cross webs.

Thus, the present invention provides a micromechanical MEMS loudspeaker device, the diaphragm movements and shutter movements of which are largely independent of one another, the arrangement of backplate and shutter relative to the sound generation device, for example, the diaphragm, being irrelevant.

Additional advantages are, among other things, a low power consumption, no drop in sound level toward lower frequencies and a small overall size.

The present invention may be advantageously used to manufacture micromechanical loudspeakers, in particular, for use in far sound field loudspeakers, as they are employed in flatscreen TVs, hands-free sets of smart phones (low overall installed size), etc.

According to one preferred refinement, the first perforated plate device is a rigid backplate and the second perforated plate device is an elastically deflectable closing device.

According to another preferred refinement, the first perforated plate device is an elastically deflectable closing device and the second perforated plate device is a rigid backplate.

According to one preferred refinement, the first perforated plate device is an elastically deflectable closing device and the second perforated plate device is an elastically deflectable closing device. To prevent energy decoupling to the packaging, it is possible to use multiple closing devices or shutters, which may be driven in opposite oscillation directions. In addition, the individual mass to be driven is reduced as a result. The individual shutter elements may be mechanically coupled to one another via a spring, in order to ensure an identical drive frequency and to prevent a divergence of phases. Moreover, multiple light/small individual shutter elements may be operated at a higher drive frequency, in addition to being modulated more rapidly in their drive frequency.

To prevent external interferences, such as linear accelerations, rotation angle accelerations or oscillations or energy losses in general via the housing, multiple shutters (at least 2, even better 4) of identical mass oscillating counter to one another may be used. If necessary, multiple diaphragms oscillating in phase may each be used with shutters oscillating in phase opposition. The shutters in this case may be operated preferably mechanically and, if necessary, fluidically in phase opposition, which allows the emission of sound energy in the high-frequency humming frequency range to be suppressed.

By separating the individual functions into separate wafers, it is possible to optimally design each of the components and to freely select their vertical distances from one another.

An operation of the loudspeaker device according to the present invention having two shutter planes instead of a shutter-backplate combination allows for a lower drive voltage, since only half the deflection of both shutter planes is required to close the perforations.

According to one preferred refinement, the second perforated plate device is formed on the second front side. Thus, only two substrates are required for assembly.

According to one preferred refinement, a third substrate is provided with a third front side, which includes a third rear side cavity, which is covered by the second perforated plate device, the third front side being bonded to the second front side. This enables a further improved oscillation decoupling.

According to one preferred refinement, the sound generation device is a diaphragm device. Such a sound generation device may be very robustly manufactured.

According to one preferred refinement, the diaphragm device includes ventilating holes provided preferably in its edge area and which are preferably controllable for opening and closing. These ventilating holes are preferably introduced with a small radius as a bypass in the edge area of the diaphragm. This prevents the formation of a negative pressure/overpressure in the back volume and, therefore, an attenuation at low frequencies, i.e., lower SPLs, and permits a static pressure compensation in the back volume. For high frequencies, the ventilating holes are not a factor due to their high fluid resistance. In this case, these ventilating holes may be replaced by micromechanical valves, i.e., controllable ventilating holes. This prevents an undesirable escaping of air during the pump cycle.

According to one preferred refinement, the closing device and/or the diaphragm device is/are elastically deflectable via a spring drive/piezo drive or via a spring drive/electrostatic drive. The spring drive/piezo drive, in particular, requires no additional electrodes.

According to one preferred refinement, the backplate includes a variable degree of perforation, which preferably decreases from its central area to its edge area. As a result, the backplate (for example 1-5 μm thickness) may thereby exhibit a preferably minimal flow resistance, that a particularly high perforation density is implemented in the area of the greatest deflection of the sound generation device, for example, the ultrasound-emitting diaphragm.

According to one preferred refinement, a fourth substrate is provided, to which the first rear side is bonded, and which includes a through-opening, which forms a fluid access to the first rear side cavity. The back volume in the first substrate is covered by the fourth substrate (possible also film-like as a fluid-permeable foil) with a through-hole or through-holes. This allows a very defined air leakage to be established for the back volume.

According to one preferred refinement, the MEMS loudspeaker device is mounted on a carrier substrate, a chamber substrate surrounding the MEMS loudspeaker device being attached to the carrier substrate, and a cover substrate being provided on the chamber substrate, which includes a sound outlet opening. To protect the loudspeaker device against penetrating particles or moisture, a flexible fluid-permeable protective foil may be provided over the sound outlet opening. In this way a simple robust packaging may be created.

According to one preferred refinement, the chamber substrate includes a central area, in which the MEMS loudspeaker device is provided, and an edge area, which is fluidically connected via a channel in the carrier substrate to the first rear side cavity in the central area, and which is otherwise fluidically decoupled from the central area. This makes a closed, relatively large back volume possible.

According to one preferred refinement, the chamber substrate includes an interior area, in which the MEMS loudspeaker device is provided, the carrier substrate including a through-opening, which forms a fluid access to the first rear side cavity. An external back volume is thus obtained.

### BRIEF DESCRIPTION OF THE DRAWINGS

FIG. 1 schematically shows a cross-sectional view of a MEMS loudspeaker device according to a first specific embodiment of the present invention.

FIG. 2 schematically shows a top view of the shutter device of the MEMS loudspeaker device according to the first specific embodiment of the present invention.

FIG. 3 schematically shows a cross-sectional view of a MEMS loudspeaker device according to a second specific embodiment of the present invention.

FIG. 4 schematically shows a cross-sectional view of a MEMS loudspeaker device according to a third specific embodiment of the present invention.

FIG. 5 schematically shows a cross-sectional view of a MEMS loudspeaker device according to a fourth specific embodiment of the present invention.

FIG. 6 schematically shows a cross-sectional view of a MEMS loudspeaker device according to a fifth specific embodiment of the present invention.

FIG. 7 schematically shows a cross-sectional view of a MEMS loudspeaker device according to a sixth specific embodiment of the present invention.

### DETAILED DESCRIPTION

In the figures, identical devices or functionally identical devices are identified by identical reference numerals.

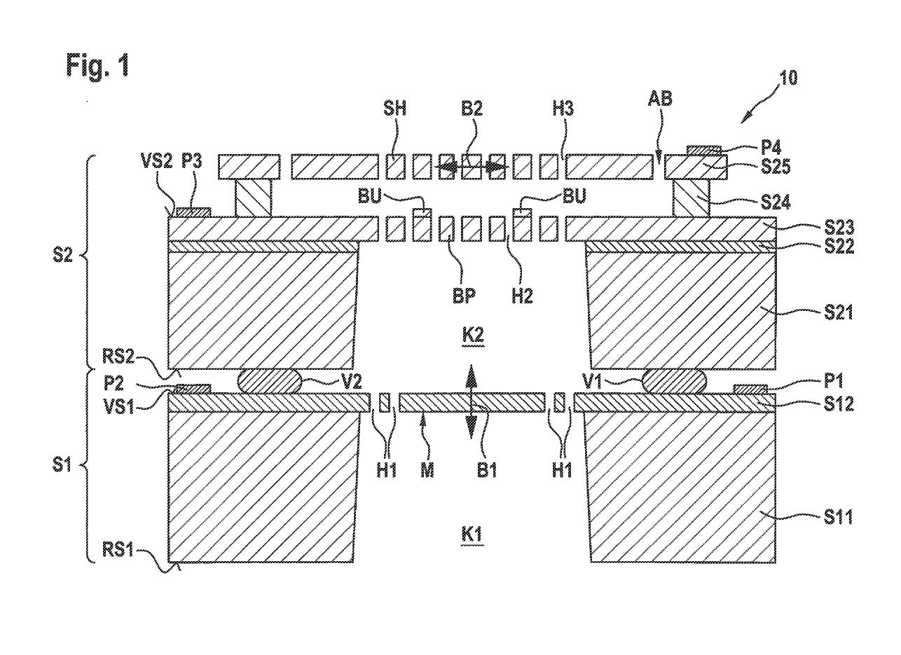

FIG. 1 is a schematic cross-sectional view of a MEMS loudspeaker device according to a first specific embodiment of the present invention.

In FIG. 1, a MEMS loudspeaker device according to the first specific embodiment of the present invention, which includes a first substrate S1 having a first front side VS1 and a first rear side RS1 and a second substrate S2 having a second front side VS2 and a second rear side RS2, is identified in general by reference numeral 10.

First substrate S1 is a silicon substrate, for example, which includes a silicon carrier area 511 on top of which a silicon functional area S12 is mounted.

A first rear side cavity K1 is provided in silicon carrier area 511, which extends from first rear side RS1 to silicon functional area S12, and which has the function of a back volume. Diaphragm device M includes ventilating holes H1, which are provided preferably in its edge area and which are controllable preferably for opening and closing in a valve-like manner.

In the oscillating state, diaphragm device M moves along first movement direction B1. The functional elements of silicon functional area S12 are electrically controlled via electrical contact pads, identified herein, for example, by reference numerals P1, P2.

In the present example, the sound generation device is a diaphragm device M, it is, however, not limited thereto, but may also assume the shape of one or multiple oscillating beams or the like.

Second substrate S2 is an SOI substrate (silicon on insulator), for example. Second substrate S2 includes a silicon carrier area S21, a silicon oxide area S22, a first silicon functional area S23, a silicon oxide compound area S24 and a second silicon functional area S25.

Second substrate S2 includes a second rear side cavity K2, which extends from second rear side RS2 to first silicon functional area S23.

A backplate BP is formed above second rear side cavity K2 in first silicon functional area S23, which is essentially fixed and includes ventilating holes H2. It should include a preferably minimal flow resistance for the sound waves of diaphragm device M, and preferably a high perforation density in the area of the greatest deflection of the diaphragm device, i.e., in its central area.

Second substrate S2 is bonded with its second rear side RS2 to first front side VS1 of first substrate S1 with the aid of bond connections V1, V2 in such a way that second rear side cavity K2 is situated above diaphragm device M, preferably resulting in a preferably large sound passage.

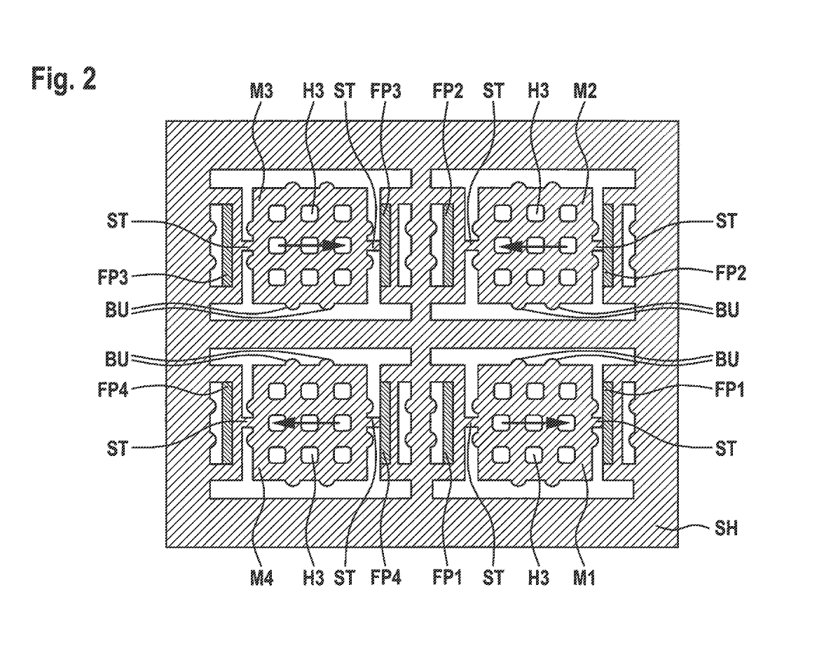

In second silicon functional area S25, a plate-shaped shutter device or closing device SH is formed above backplate BP, which also includes ventilating holes H3, and which is elastically deflectable in its plate plane in a second movement direction B2. The deflection takes place via a drive area AB, which will be explained in greater detail below with reference to FIG. 2. Second movement direction B2 is selected essentially perpendicular to first movement direction B1 in such a way that a passage of sound of diaphragm device M may be modulated by an interaction of backplate BP and closing device SH, so that the loudspeaker function is implementable with the aid of acoustic beats. Electric contact pads, identified herein by P3, P4, for example, are also provided for driving closing device SH.

Since it is not possible in practice to implement a pure movement in the plate plane of closing device SH, stop bumps, identified herein by reference sign BU, may also be provided for safety reasons, both on backplate BP and on closing device SH.

Although closing device SH is located above backplate BP in the present example, the order may also be reversed, since only the possibility of acoustic modulation via the movement along second movement direction B2 is relevant for the functioning of the loudspeaker device.

During operation as a loudspeaker, a frequency of several hundred kHz is applied to diaphragm device M, for example, and this frequency is modulated with the same frequency +20 kHz or −20 kHz via closing device SH, the range of 0-20 kHz corresponding exactly to the acoustic audible range. It is also possible, of course, to operate closing device SH at a constant frequency and to operate diaphragm device M frequency modulated.

FIG. 2 is a schematic top view of the shutter device of the MEMS loudspeaker device according to the first specific embodiment of the present invention.

In FIG. 2, shutter device or closing device SH is depicted, which in this example 4 includes plate-shaped elastically suspended oscillating weights M1, M2, M3 and M4, which are operated in phase opposition as depicted by the arrows. Oscillating weights M1, M2, M3, M4 are each connected on both sides via webs ST to a corresponding spring drive/piezo drive FP1, FP2, FP3, FP4, each of which ensures the deflection in the plate plane out of the rest position, the return force being generated by the corresponding springs.

Stop bumps BU′ on oscillating weights M1, M2, M3 and M4 ensure that undesirable movements perpendicular to the second movement direction B2 are unable to cause any damage.

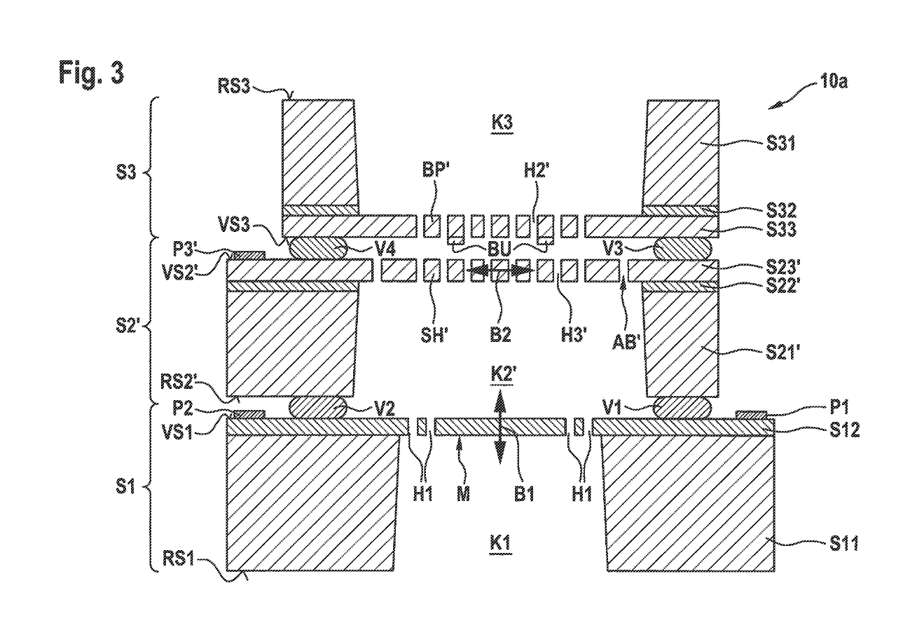

FIG. 3 is a schematic cross-sectional view of a MEMS loudspeaker device according to a second specific embodiment of the present invention.

In FIG. 3, a MEMS loudspeaker device according to the second specific embodiment, in which the structure and function of first substrate S1 are the same as described above in the first specific embodiment, is identified in general by reference numeral 10a.

In this specific embodiment, a second substrate S2′ having a second rear side cavity K2′ is also a SOI substrate including a silicon carrier area S21′, a silicon oxide area S22′ and a silicon functional area S23′. In contrast to the first specific embodiment, a closing device SH′ is provided in silicon functional area S23′, which is movable in second movement direction B2 and which includes ventilating holes H3′ above rear side cavity K2′, which extend from second rear side RS2′ to silicon functional area S23′. Second rear side RS2′ is bonded to first front side VS1 with the aid of bond connections V1, V2, similar to the first specific embodiment.

Electrical contact pads are used to drive closing device SH′, which is identified herein, for example, by reference numeral P3′. The function of closing device SH′ is identical, as is described above with reference to the first specific embodiment. The drive area is identified herein by reference sign AB′.

In the second specific embodiment, a third substrate S3 is also provided, which includes a third front side VS3 and a third rear side RS3.

Third substrate S3 in this example is also a SOI substrate including a silicon carrier area S31, a silicon oxide area S32 and a silicon functional area S33. In silicon functional area S33, an essentially rigid backplate BP′ including ventilating holes H2′ is provided, which interacts with closing device SH′ as in the first specific embodiment described above.

Third front side VS3 is bonded to second front side S2′ of second substrate S2′ with the aid of bond connections V3, V4, so that closing device SH′ and backplate BP′ lie on top of each other.

By implementing third rear side cavity K3, it is possible to achieve a more directed sound emission in this second specific embodiment. This third rear side cavity K3 is, of course, optional.

In the second specific embodiment as well, which uses three substrates S1, S2′, S3, it is possible to switch the order of closing device SH′ and backplate BP′, i.e., backplate BP′ is provided in second substrate S2′ and closing device SH′ is provided in third substrate S3.

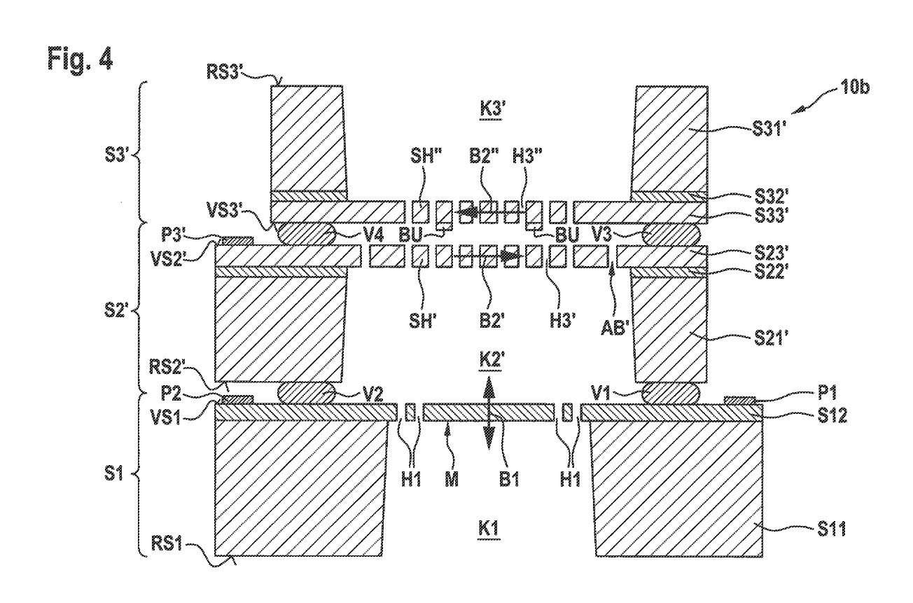

FIG. 4 is a schematic cross-sectional view of a MEMS loudspeaker device according to a third specific embodiment of the present invention.

In FIG. 4, a MEMS loudspeaker device according to the third specific embodiment, in which the structure and function of first substrate S1 and of second substrate S2′ are the same as described above in the second specific embodiment, is identified in general by reference numeral 10b.

In contrast to the second specific embodiment, a second closing device or shutter device SH″ including ventilating holes H3″ above a third rear side cavity K3′ is provided in the third specific embodiment in third substrate S3′ having a third front side VS3′ and a third rear side RS3′, which is a SOI substrate and includes a silicon carrier area S21′, a silicon oxide area S22′ and a silicon functional area S23′. In this specific embodiment, first closing device SH′ and second closing device SH″ are operated in phase opposition, as is indicated by arrows B2′ and B2″.

As a result of the operation in phase opposition of first closing device SH′ and second closing device SH″, the mass to be driven is reduced. The individual elements of closing devices SH′ and SH″ may be mechanically coupled to one another via springs (not shown), in order to ensure an identical drive frequency and to prevent a divergence of the phases.

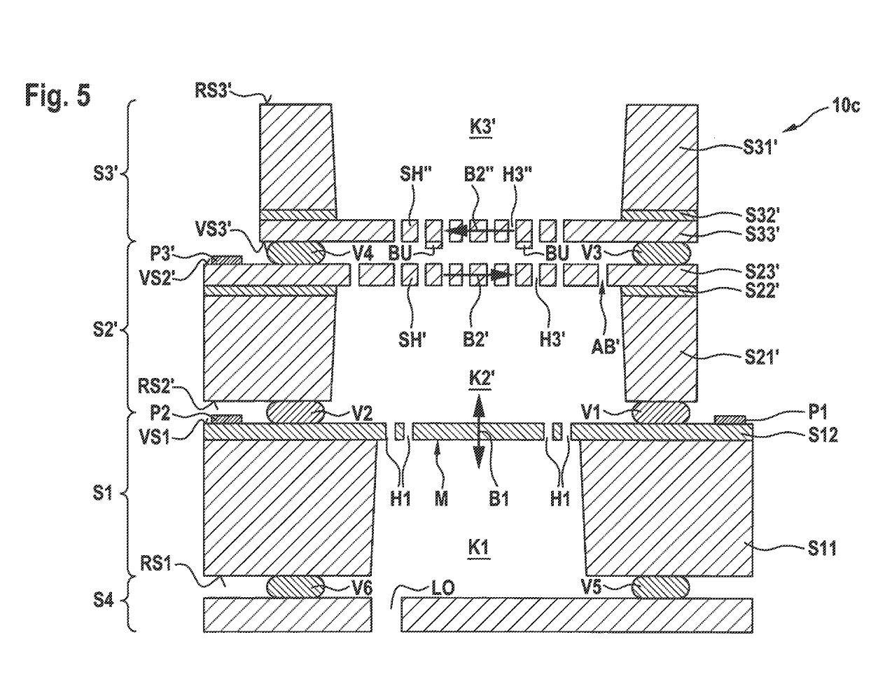

FIG. 5 is a schematic cross-sectional view of a MEMS loudspeaker device according to a fourth specific embodiment of the present invention.

In contrast to the third specific embodiment, a fourth substrate S4, for example, a silicon substrate, is provided below first substrate S1 in MEMS loudspeaker device 10c according to the fourth specific embodiment, to which first rear side RS1 of the first substrate is bonded with the aid of bond connections V5, V6. Fourth substrate S4 includes a through-opening LO in the area of first rear side cavity K1, which creates an external fluid access.

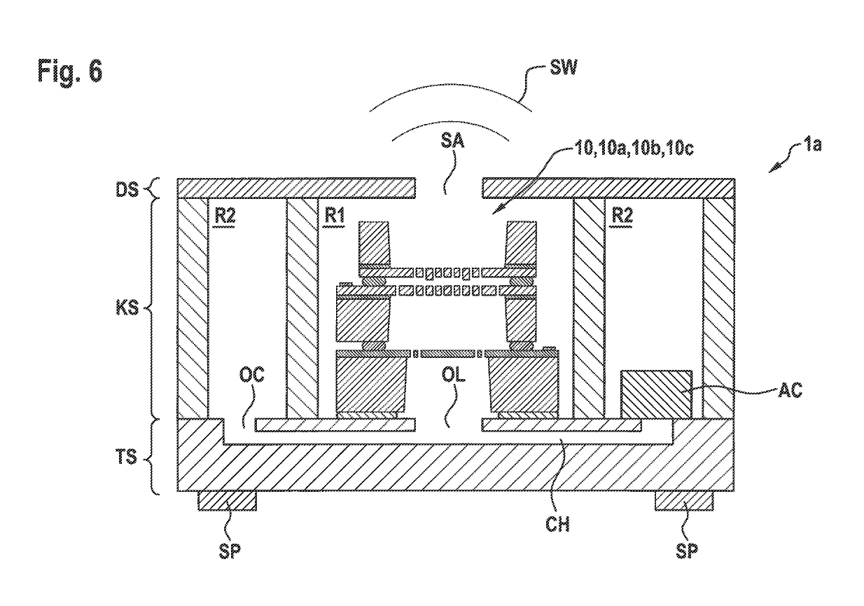

FIG. 6 is a schematic cross-sectional view of a MEMS loudspeaker device according to a fifth specific embodiment of the present invention.

In the fifth specific embodiment, MEMS loudspeaker devices 10, 10a, 10b, 10c described above are depicted in the packaged state. Here, the packaged loudspeaker device in general bears reference numeral 1a. For this purpose, any one of the MEMS loudspeaker devices 10, 10a, 10b, 10c is mounted on a carrier substrate TS with mounting pads SP. Attached to carrier substrate TS is a chamber substrate KS surrounding the MEMS loudspeaker device, a cover substrate DS being provided on chamber substrate KS, which includes a sound outlet opening SA for sound waves SW to exit above the MEMS loudspeaker device.

Chamber substrate KS includes a central area R1, in which MEMS loudspeaker device 10, 10, 10b, 10c is provided, as well as an edge area R2, which is fluidically connected to first rear side cavity K1 in central area R1 via a channel CH in carrier substrate TS, and is otherwise fluidically decoupled from central area R1. For this purpose, the channel includes a first opening OL and a second opening OC. Edge area R2 serves as back volume.

Additional components may be mounted in edge area R2 such as, for example, an ASIC with reference sign AC. It is also possible to provide additional components and corresponding electrical connections.

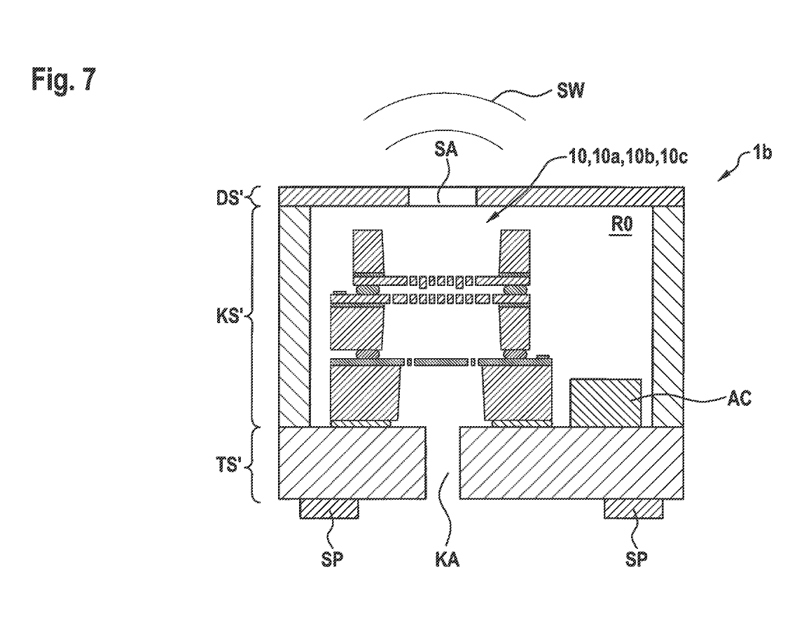

FIG. 7 is a schematic cross-sectional view of a MEMS loudspeaker device according to a sixth specific embodiment of the present invention.

In the sixth specific embodiment, the packaged loudspeaker device in general bears the reference numeral 1b. Here, the carrier substrate is identified by reference sign TS' and includes a through-opening KA as a fluid access for first rear side cavity K1 of MEMS loudspeaker device 10, 10a, 10b and 10c. The chamber substrate is identified by reference sign KS' and is designed in such a way that it includes a single interior space R0, in which MEMS loudspeaker device 10, 10a, 10b and 10c is mounted.

Cover substrate DS' includes, as in the fifth specific embodiment, a sound outlet opening SA for the passage of sound waves SW of MEMS loudspeaker device 10, 10a, 10b and 10c. The packaged loudspeaker device designed in this way is mountable on arbitrary carriers with the aid of mounting pads SP.

Although the present invention has been described based on preferred exemplary embodiments, it is not limited thereto. The cited materials and topologies, in particular, are merely exemplary and not limited to the explained examples.

Although the closing devices in the specific embodiments described above include multiple oscillating weights, it is of course possible in each case to provide one closing device, which includes only one single oscillating weight.

It should also be mentioned that it is possible, of course, to construct assemblies or arrays based on the loudspeaker devices described above, which include a plurality of sound generation devices or diaphragm devices arranged in a matrix, in each case, with closing devices and backplates located above. Either individual or multiple or all of the diaphragm devices or closing devices may each share a common cavity or rear side cavity. Nor is the present invention limited to the number of closing devices or backplates stacked on top of one another.

What is claimed is:

1. A MEMS loudspeaker device, comprising:
a sound generation device;
a first substrate having a first front side and a first rear side and including a first rear side cavity that is at least partially covered by the sound generation device;
a first perforated plate device;
a second substrate having a second front side and a second rear side and including a second rear side cavity that is covered by the first perforated plate device, wherein the second substrate is bonded to the first front side in such a way that the second rear side cavity is situated above the sound generation device; and
a second perforated plate device attached above the first perforated plate device, wherein at least one of the first perforated plate device and the second perforated plate device is elastically deflectable in such a way that a passage of sound of the sound generation device may be modulated by an interaction of the first perforated plate device and the second perforated plate device.

2. The MEMS loudspeaker device as recited in claim 1, wherein:
the first perforated plate device is a rigid backplate, and
the second perforated plate device is an elastically deflectable closing device.

3. The MEMS loudspeaker device as recited in claim 1, wherein:
the first perforated plate device is an elastically deflectable closing device, and
the second perforated plate device is a rigid backplate.

4. The MEMS loudspeaker device as recited in claim 1, wherein:
the first perforated plate device is an elastically deflectable closing device, and
the second perforated plate device is an elastically deflectable closing device.

5. The MEMS loudspeaker device as recited in claim 1, wherein the second perforated plate device is formed on the second front side.

6. The MEMS loudspeaker device as recited in claim 1, further comprising:
a third substrate including a third front side and including a third rear side cavity covered by the second perforated plate device, wherein the third front side is bonded to the second front side.

7. The MEMS loudspeaker device as recited in claim 1, wherein the sound generation device is one of a diaphragm device and a cantilever.

8. The MEMS loudspeaker device as recited in claim 7, wherein the diaphragm device includes ventilating holes provided preferably in an edge are of the diaphragm device, the holes being controllable for opening and closing.

9. The MEMS loudspeaker device as recited in claim 2, wherein at least one of the closing device and the sound generation device is elastically deflectable via one of a spring drive/piezo drive and a spring drive/electrostatic drive.

10. The MEMS loudspeaker device as recited in claim 2, wherein the backplate includes a variable degree of perforation that decreases from a center area of the backplate to an edge area of the backplate.

11. The MEMS loudspeaker device as recited in claim 1, further comprising:
a fourth substrate to which the first rear side is bonded and which includes a through-opening that forms a fluid access to the first rear side cavity.

12. The MEMS loudspeaker device as recited in claim 1, which is mounted on a carrier substrate, wherein a chamber substrate surrounding the MEMS loudspeaker device is attached to the carrier substrate and a cover substrate is provided on the chamber substrate, the cover substrate including a sound outlet opening.

13. The MEMS loudspeaker device as recited in claim 12, wherein:
the chamber substrate includes a central area in which the MEMS loudspeaker device is provided, and
the chamber substrate includes an edge area that is fluidically connected to the first rear side cavity in the central area via a channel in the carrier substrate, and that is otherwise fluidically decoupled from the central area.

14. The MEMS loudspeaker device as recited in claim 12, wherein the chamber substrate includes an interior area, in which the MEMS loudspeaker device is provided, the carrier substrate including a through-opening that forms a fluid access to the first rear side cavity.

15. A method for manufacturing a MEMS loudspeaker device, comprising:
forming a first substrate having a first front side and a first rear side, the first substrate including a first rear side cavity that is at least partially covered by a sound generation device;
forming a second substrate having a second front side and a second rear side, the second substrate including a second rear side cavity that is covered by a first perforated plate device;
bonding the second substrate to the first front side in such a way that the second rear side cavity is situated above the sound generation device; and
forming a second perforated plate device that is attached above the first perforated plate device, wherein at least one of the first perforated plate device and the second perforated plate device is formed elastically deflectable in such a way that a passage of sound of the sound generation device may be modulated by an interaction of the first perforated plate device and the second perforated plate device.
